(19) United States
(12) Patent Application Publication
(10) Pub. No.: US 2025/0231629 A1
(43) Pub. Date: Jul. 17, 2025

(54) IRRIGATION CONTROLLER WITH MULTI-FUNCTION ROTARY DIAL AND PROGRAMMING METHODS

(71) Applicant: Rain Bird Corporation, Azusa, CA (US)

(72) Inventors: Gustavo Corona, Chula Vista, CA (US); Bret A. Ramsey, Auburn, CA (US); Serge Gauthier, Bromont (CA); Martin C. Martinez, El Cajon, CA (US)

(21) Appl. No.: 19/026,101

(22) Filed: Jan. 16, 2025

Related U.S. Application Data
(60) Provisional application No. 63/621,574, filed on Jan. 16, 2024.

(51) Int. Cl. G06F 3/0362; A01G 25/16; G06F 3/04812; G06F 3/0482

(52) U.S. Cl. CPC G06F 3/0362; A01G 25/16; G06F 3/04812; G06F 3/0482

(57) ABSTRACT

In some embodiments, apparatuses, methods, and user interfaces are provided herein useful to control settings of an irrigation controller and including a housing, a display screen, a multi-function rotary dial coupled to the housing and configured to be rotated and pressed, and a control circuit configured to execute code to receive user input based on rotation of the multi-function rotary dial by a user and based on depression of the multi-function rotary dial by the user, and to cause content to be responsively displayed to the user on the display screen.

### CROSS-REFERENCE TO RELATED APPLICATIONS

This application claims the benefit of U.S. Provisional Application No. 63/621,574, filed Jan. 16, 2024, and entitled IRRIGATION CONTROLLER WITH MULTI-FUNCTION ROTARY DIAL AND PROGRAMMING METHODS (Attorney Docket No. 8473-159189-US), which is incorporated herein by reference in its entirety.

### TECHNICAL FIELD

This disclosure relates generally to irrigation controllers and, in particular, to irrigation controllers having controls that may be manually manipulated by users.

### BACKGROUND

Irrigation controllers are known to have controls such as implemented on control panels that utilize a combination of buttons and rotary dials to manage and adjust various irrigation settings. The buttons and rotary dials may allow users to input commands such as selecting irrigation zones, setting watering durations, and adjusting schedules. While these buttons and rotary dials can offer a degree of control to a user, they may present significant drawbacks in terms of usability, particularly when toggling between multiple selectable fields displayed on the control panel. For example, the user may have to manually press buttons or rotate dials repeatedly to navigate through a menu on a display, which can be tedious, time-consuming, and/or prone to error, especially when dealing with complex or numerous settings. This inefficiency may lead to frustration for users who need to make frequent adjustments, particularly in scenarios, where rapid or precise navigation between different fields/settings is required. Therefore, there is a need for an improved irrigation controller interface that allows for more intuitive and efficient control of irrigation settings.

### BRIEF DESCRIPTION OF DRAWINGS

Disclosed herein are embodiments of systems, methods, and user interfaces and controls relating to irrigation controllers for monitoring and/or controlling an irrigation system. This description includes drawings, wherein:

FIG. 1 illustrates an exemplary irrigation system in accordance with some embodiments;

FIGS. 2A and 2B illustrates exemplary known irrigation controller control panels;

FIG. 3A illustrates a control panel for an irrigation controller including a multi-function rotary dial in accordance with some embodiments;

FIG. 3B is a functional block diagram of an exemplary irrigation controller in accordance with some embodiments;

FIGS. 4A and 4B provide exemplary display screen illustrations where rotating and pressing the rotary dial navigates various menus and inputs data in accordance with some embodiments;

FIG. 5 provides exemplary display screen illustrations where pressing a button on an irrigation controller in conjunction with rotating the rotary dial navigates various menus in accordance with some embodiments;

FIG. 6 provides an exemplary display screen illustration of a menu that may be navigated and/or that may be used to input data by way of rotating and pressing the rotary dial in accordance with some embodiments;

FIG. 7 provides an exemplary display screen illustration of a menu that may be navigated and/or that may be used to input data by way of rotating and pressing the rotary dial in accordance with some embodiments;

FIG. 8 provides an exemplary display screen illustration of a menu that may be navigated and/or that may be used to input data by way of rotating and pressing the rotary dial in accordance with some embodiments;

FIG. 9 provides an exemplary display screen illustration of a menu that may be navigated and/or that may be used to input data by way of rotating and pressing the rotary dial in accordance with some embodiments;

FIG. 10 provides an exemplary display screen illustration of a menu that may be navigated and/or that may be used to input data by way of rotating and pressing the rotary dial in accordance with some embodiments;

FIG. 11 provides an exemplary display screen illustration of a menu that may be navigated and/or that may be used to input data by way of rotating and pressing the rotary dial in accordance with some embodiments;

FIG. 12 provides an exemplary display screen illustration of a menu that may be navigated and/or that may be used to input data by way of rotating and pressing the rotary dial in accordance with some embodiments;

FIG. 13 provides an exemplary display screen illustration of a menu that may be navigated and/or that may be used to input data by way of rotating and pressing the rotary dial in accordance with some embodiments;

FIG. 14 provides an exemplary display screen illustration of a menu that may be navigated and/or that may be used to input data by way of rotating and pressing the rotary dial in accordance with some embodiments;

FIGS. 15A-15D provide exemplary display screen illustrations of menus that may be navigated and/or that may be used to input data by way of rotating and pressing the rotary dial in accordance with some embodiments;

FIG. 16 shows a simplified flow diagram illustrating a method of controlling settings of an irrigation controller in accordance with some embodiments; and

FIG. 17 shows a simplified flow diagram illustrating a method of entering settings of an irrigation controller in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms/expressions used herein have the ordinary technical meaning as is accorded to such terms and expressions by persons skilled in the technical field as set forth above except where different specific meanings have otherwise been set forth herein.

### DETAILED DESCRIPTION OF THE INVENTION

The following description is not to be taken in a limiting sense, but is made merely for the purpose of describing the general principles of exemplary embodiments. The scope should be determined with reference to any claims. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, in some embodiments, irrigation controllers are provided that use a multi-function rotary dial having the functionality of rotating and being pressed like a button for use in programming and/or navigating the settings of the irrigation controllers. In some embodiments, the rotation and button functionality of the rotary dial of an irrigation controller control panel may be used together with a display screen and/or a button of the control panel to navigate menu options, select menu options, and/or enter data or other parameters by similarly rotating and pressing the rotary dial.

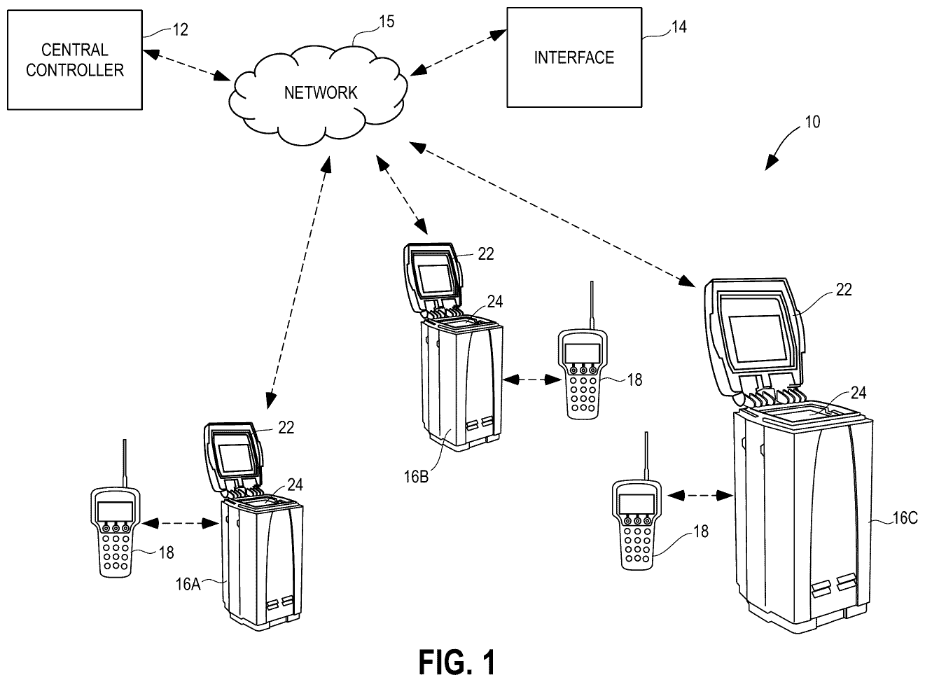

Referring to FIG. 1, in some embodiments, an irrigation control system 10 for controlling irrigation at one or more irrigation sites 20 includes a central controller 12, one or more interface units 14, and satellite controllers 16A-16C. The satellite controllers 16A-16C are each coupled to and control irrigation valves or stations that control water flow to one or more sprinklers.

In some aspects, the central controller 12 is a computer or server having irrigation control software that allows users to create watering schedules to coordinate watering at an irrigation site 20. For example, the central controller 12 may be a stationary or portable electronic device, for example, a desktop computer, a laptop computer, a server, multiple communicatively connected servers, a distributed computer, a tablet computer, a mobile phone, a personal digital assistant (PDA), a smartwatch or other wearable device, or any other electronic device including a control circuit (e.g., processor) that executes software for purposes of controlling irrigation at one or more irrigation sites 20.

If the irrigation site 20 is a golf course, for example, there may be dozens, or hundreds of satellite controllers 16A-16C spread throughout the irrigation site 20. In some aspects, the interface units 14 receive schedules and/or commands from the central controller 12 and communicate those to the satellite controllers 16A-16C. In some aspects, the central controller 12 may transmit schedules and/or commands to the satellite controllers 16A-16C directly, i.e., without using one or more interface units 14 as an intermediary. The satellite controllers 16A-16C can store and execute schedules, or can receive signals based on schedules stored at and executed by the central controller 12. In some aspects, users at the irrigation site 20 can use a handheld remote 18 to directly communicate with a given satellite controller 16.

The exemplary electronic devices shown in FIG. 1 namely, central controller 12, interface unit 14, satellite controllers 16A-16C, and handheld remotes 18 may be configured for communication with each other and other devices of the irrigation control system 10 via a network 15. The exemplary network 15 depicted in FIG. 1 may be any computer connection network, e.g., including one or more of a wide-area network (WAN), a local area network (LAN), a personal area network (PAN), a wireless local area network (WLAN), a wired network, a wireless network, or any other internet or intranet network, or combinations of such networks.

Generally, communication between various electronic devices of irrigation control system 10 may take place over hard-wired, wireless, cellular, LoRa, LoRaWAN, Zigbee, Wi-Fi or Bluetooth (e.g., Bluetooth Low Energy (BLE)) networked components or the like. In some embodiments, one or more electronic devices of irrigation control system 10 may include cloud-based features, such as cloud-based memory storage.

In some aspects, users at the irrigation site 20 can interact directly with a satellite controller 16A-16C via its control panel 24. For example, individual satellite controllers 16A-16C typically have a cover or lid 22 that can be opened to reveal a control panel 24 (see enlarged satellite controller 16C in FIG. 1).

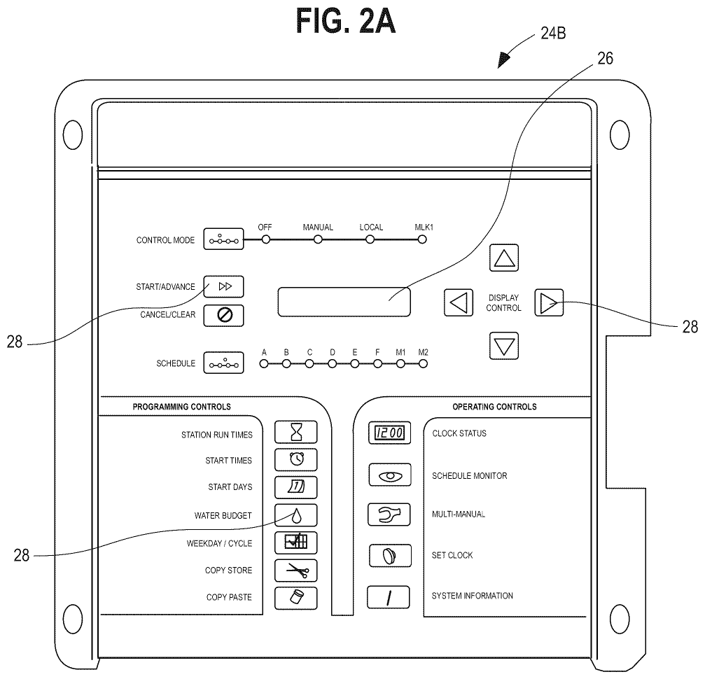

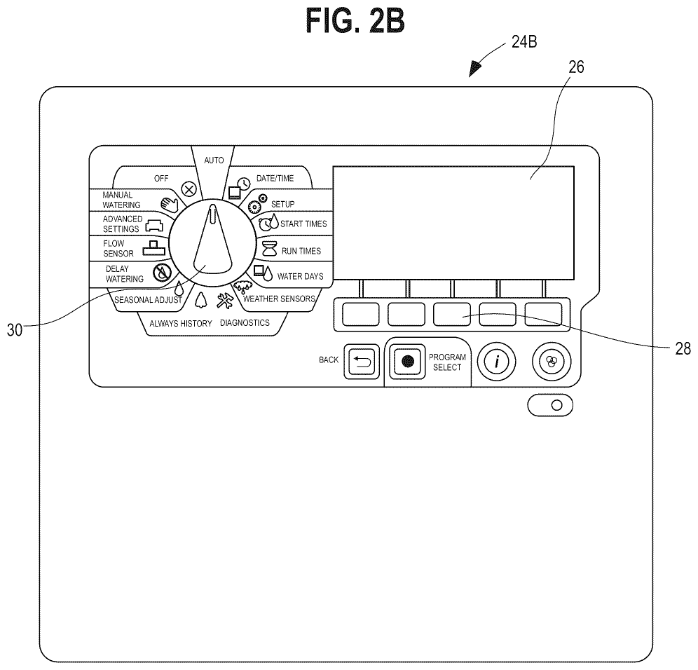

FIGS. 2A and 2B show examples of known control panels 24A and 24B of satellite controllers. The control panel 24A of FIG. 2A has a display screen 26 and a variety of buttons 28 that may be pressed by a user. To interact with a controller controlled by the control panel 24A, the user operates the buttons 28 together with viewing information on the display screen 26.

The control panel 24B of FIG. 2B is similar to the control panel 24A of FIG. 2A, but includes a rotary dial 30. The rotary dial 30 is capable of making a full 360-degree rotation and typically has several defined stops that each correspond to different modes of operation of the controller. After the rotary dial 30 is positioned at a particular defined stop to cause a menu associated with a certain mode of operation to be displayed on a display screen 26 of the control panel 24B, the user interacts via the buttons 28 with the information displayed on the display screen 26 to navigate menus, make selections, and/or enter data.

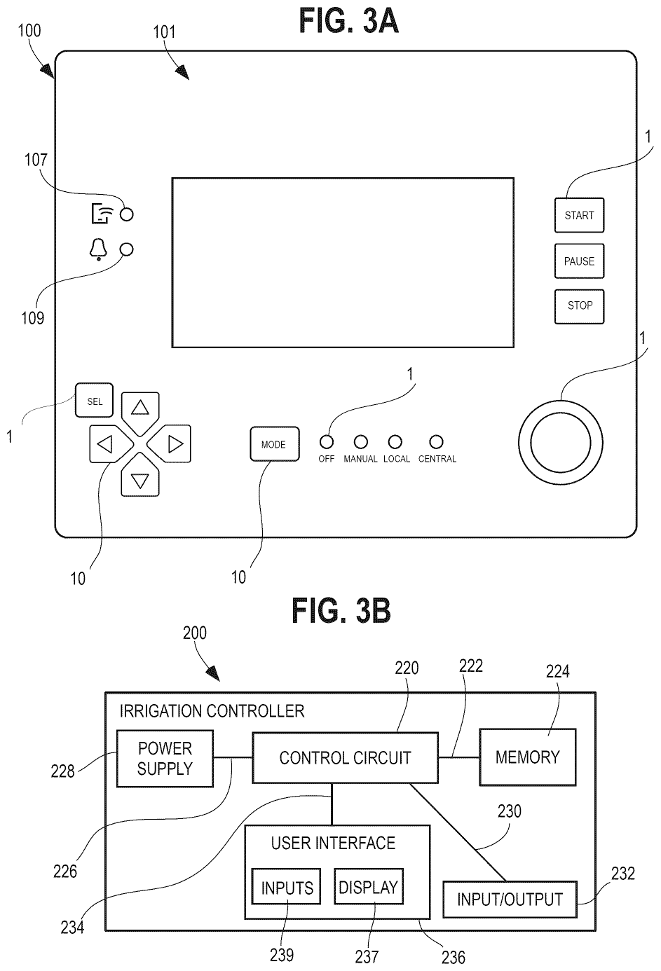

FIG. 3A shows an improved control panel 100, e.g., for satellite controllers 16A-16C, in accordance with some embodiments. The exemplary control panel 100 shown in FIG. 3A includes a housing 101 that includes buttons 104A-104D, a display screen 106, and a multi-function knob or rotary dial 102 that, in some embodiments, may operate independently of the buttons 104, or together with the buttons 104, to permit a user to navigate and/or make selections in and/or input data into a menu displayed on the display screen 106 of the control panel 100.

In the illustrated embodiment, the rotary dial 102 is operably coupled to the housing 101 such that the rotary dial 102 is permitted to rotate in either direction with a freedom of movement of 360 degrees and has no defined start or stop position. In other words, the exemplary rotary dial 102 is permitted to freely make a full 360-degree rotation clockwise or counterclockwise without stopping at a pred-defined stop. In addition, as mentioned above, the rotatable dial 30 of the control panel 24B is shaped like an arrow-head and is rotated to pre-defined stops such that the “pointy” end of the arrow-head (which acts as a visual position indicator of the rotatable dial 30) is aligned with a user-selected mode indicator (which may be pre-printed on the body of the control panel 24B) to enable the user to easily see which operation mode the rotary dial 30 is turned to at any given moment. On the other hand, the exemplary rotary dial 102 of the control panel 100 of FIG. 3A is circular in shape, and does not include any visual position indicators which indicate a direction in which the rotary dial 102 is pointing. By the same token, the housing 101 of the control panel 100 does not include any printed visual indicators of various modes that may be selected by the user by pointing the rotary dial 102 in a specific direction.

In the illustrated embodiment, the rotary dial 102 is also operably coupled to the housing 101 such that the rotary dial 102 may be pressed (e.g., by a user) to make selections (e.g., within the menus displayed on the display screen 106). In other words, the exemplary rotary dial 102 also has a button function.

With reference to FIGS. 2A and 2B, conventional control panels 24B of conventional satellite controllers have used rotary dials 30 such as shown in FIG. 2B, but such dials 24B have been limited in movement by having specific, defined stops, and did not include the capability of being pressed like a button. Without wishing to be limited to theory, conventional rotary dials 30 of known control panels 24B have been used to select an operation mode, and then the buttons 28 and display screen 26 are used for menu navigation and selection within the menu. On the other hand, in accordance with some embodiments, the rotary dial 102 shown in FIG. 3A advantageously allows for menu navigation, menu option selection, and data entry to be done using the rotary dial 102 (alone or in combination with one of the buttons 104A-104D being pressed) to control the movement of a cursor within a menu and/or to edit and/or select a value within the menu and/or to input a value into the menu.

With reference to FIG. 3A, the exemplary control panel 100 includes various buttons, 104A-104D. The button 104A (which, in this example, is called “Mode”) permits the user to select a mode of operation. The buttons 104B (which, in this example, are called “Start,” “Stop,” and “Pause”) permit the user to start/stop/pause irrigation. The buttons 104C (which in this example, are in the form of up, down, left and right arrows) permit the user to directionally navigate within a menu on the display screen 106 (in addition to or instead of navigation within the menu via the rotary dial 102). The button 104D (which may be called “Fn” or “Sel”) provides the user with additional functions, which may enhance the functioning of the rotary dial 102 to facilitate the menu navigation and/or selection of various in-menu options by the user.

In the illustrated embodiment, the control panel 100 includes indicator lights 105 associated with the button 104A (i.e., “Mode”), one of which (e.g., the indicator light named “Off”) may illuminate when the control panel 100 is in the off mode, another one of which (e.g., the indicator light named “Manual”) may illuminate when the control panel 100 is in a mode, where the user directly controls the irrigation system 10 by making inputs and/or selections via the control panel 100, another one of which (e.g., the indicator light named “Local”) may illuminate when the control panel 100 is in a mode, where a user controls the irrigation control system 10 at a local level (e.g., on-site via the control panel 100 itself rather than remotely), and another one of which (e.g., the indicator light named “Central”) may illuminate when the control panel 100 is in a mode, where a user controls the irrigation control system 10 at a central level (e.g., remotely, not locally via the control panel 100 itself).

In the embodiment illustrated in FIG. 3A, the control panel 100 includes an indicator light 107, which may be illuminated when an external device (such as a mobile device) is actively connected to the satellite controller 106A-106C associated with the control panel 100, and which is not illuminated when the external device is not actively connected to the satellite controller 106A-106C associated with the control panel 100. In addition, the exemplary control panel 100 illustrated in FIG. 3A includes an indicator light 109, which may be illuminated when there is an active alarm, and which is not illuminated when there is no active alarm.

In some embodiments, rotation of the rotary dial 102 (e.g., clockwise or counterclockwise) can be used for menu navigation and/or for toggling a cursor between various fields of the menu, and depression of the rotary dial 102 (i.e., by pushing/pressing it like a button) may be used for selection of a menu option and/or for input of data into a field of a menu and/or for editing data in a field of a menu. For example, in some aspects, when the user is viewing the menu on the screen 106 of the control panel 100 and a cursor is positioned on a field of the menu that may be selectable by a user, the user may press the rotary dial 102 downward (like a button) to execute a user selection of that field and, for example, either open a sub-menu with more user-selectable options, or activate an interactive field with user-editable values.

In another example, while a user is viewing a menu on the screen 106 of the control panel 100, a cursor (which will be discussed in more detail below) may highlight a certain user-selectable field of the menu when positioned thereon, and the user may rotate the rotary dial 102 in a clockwise direction to move the cursor within the menu in a downward direction (i.e., to move the cursor to a field directly below the field on which the cursor was positioned prior to the clockwise rotation of the rotary dial 102 by the user). Conversely, while the user is viewing the menu on the screen 106 of the control panel 100, the user may rotate the rotary dial 102 in a counterclockwise direction to move the cursor within the menu in an upward direction (i.e., to move to a field directly above the field on which the cursor was positioned prior to the rotation of the rotary dial 102 by the user in the counterclockwise direction).

In certain aspects, when the user is viewing the menu on the screen 106 of the control panel 100 and a cursor is positioned on an interactive field, the user may press the rotary dial 102 downward (like a button) to activate the interactive field and cause this interactive field to enter an active value selection mode. In some implementations, while the user is viewing a menu on the screen 106 of the control panel 100 and a cursor is positioned on a field that is in the active value selection mode, the rotation of the rotary dial 102 by the user in a counterclockwise or clockwise direction may cause a value in the interactive field to be increased or decreased depending on the direction of movement of the rotary dial 102, after which the rotary dial 102 may pressed by the user to confirms the user's final selection of a user-desired value in the interactive field.

With reference to FIG. 3B, an exemplary irrigation controller 200 akin to the satellite controllers 16A-16C of FIG. 1 and configured for use with exemplary systems and methods described herein may include a control circuit 220 electrically coupled via a connection 222 (e.g., a bus, etc.) to a memory 224 and via a connection 226 (e.g., a bus, etc.) to a power supply 228. In some embodiments, the control circuit 220 is a programmable processor (e.g., a microprocessor or a microcontroller). And in some embodiments, the control circuit 220 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description.

The control circuit 220 can be configured (for example, by using corresponding programming stored in the memory 224 (such as an irrigation management application) as will be well understood by those skilled in the art) to carry out one or more of the steps, actions, and/or functions described herein. In some embodiments, the memory 224 may be integral to the control circuit 220 or can be physically discrete (in whole or in part) from the control circuit 220 and may be configured to non-transitorily store the computer instructions that, when executed by the control circuit 220, cause the control circuit 220 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 224 may be referred to as a non-transitory medium or non-transitory computer readable medium.

The control circuit 220 of the irrigation controller 200 may be also electrically coupled via a connection 230 to an input/output 232 that can receive signals from other devices, for example, the central controller 12, interface unit 14, remote 18, and/or from another electronic device of the irrigation control system 10 or in communication with the irrigation control system 10. The input/output 232 of the irrigation controller 200 can also send signals to other devices, for example, central controller 12, interface 14, other irrigation controllers 200, etc. In some embodiments, the input/output 232 may include components for wired and/or wireless connection or coupling with the irrigation controller 200.

The control circuit 220 of the exemplary irrigation controller 200 shown in FIG. 3B may be electrically coupled via a connection 234 to a user interface 236, which may be in the form of a control panel 100 as shown in FIG. 3A. The user interface 236 may include a visual display or display screen 237, which may be an LED screen, and which may be in the form of the display screen 106 as shown in FIG. 3A. The user interface 236 may also include input(s) 239, which may be in the form of the rotary dial 102 and/or buttons 104A-104D, 105, 107, and 109 as shown in FIG. 3A, and which may provide the user interface 236 with the ability to permit a user of the irrigation controller 200 to monitor and/or control the irrigation control system 10 by inputting menu and/or value selections and/or commands as mentioned above and will be described in more detail below.

It will be appreciated that the performance of such functions by the control circuit 220 of the irrigation controller 200 may not be dependent on a human operator, and that the control circuit 220 of the irrigation controller 200 may be programmed to perform such functions without a human operator. In some embodiments, the user interface 236 is integral to and forms a part of the irrigation controller 200 (e.g., the control panel 100 may be built into the satellite controller 16C and is not intended to be operated while removed from the satellite controller 16C (but may be removable from the satellite controller 16C, e.g., for maintenance or repair purposes). In some implementations the user interface 236 is removable from the irrigation controller 200 (e.g., the control panel 100 may operate while partially or fully detached from the satellite controller 16C).

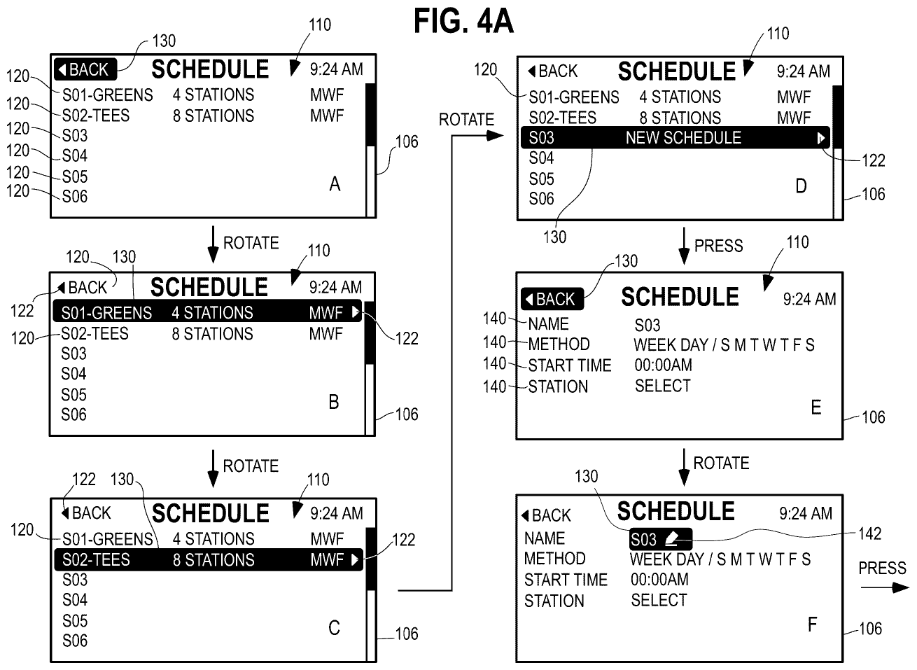

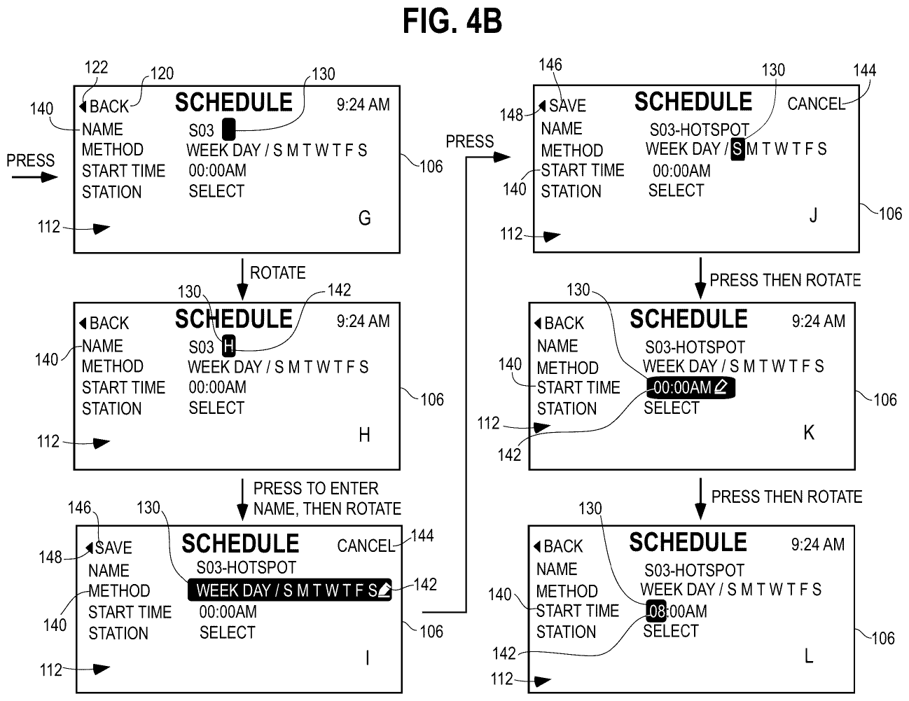

FIGS. 4A and 4B show various illustrations (identified as screen images or screens A-L in FIGS. 4A-4B) of the display screen 106 of the control panel 100 while a menu 110 is visible on the display screen 106. FIGS. 4A and 4B represent an example of how rotation and depression of the rotary dial 102 by a user enables the user to navigate within the menu within the menu, make selections within the menu, input and edit data within the menu, and/or exit the menu according to some embodiments.

Screen A of FIG. 4A shows a menu 110 including interactive user-selectable fields 120 (which, for simplicity, are also referred to herein simply as “fields”) and a user-visible cursor 130, which may be toggled between the fields 120 of the menu 110 by the user, e.g., via rotation of the rotary dial 102 (FIG. 3A). In screen A of FIG. 4A, a field 120 called “BACK” is highlighted by a cursor 130. In the menu 110 shown in Screen A of FIG. 4A, the field 120 includes a visual indicator 122 (in this example, a left-pointing triangle), which indicates to a user that selecting the field 120, for example, via depression of the rotary dial 102 while the cursor 130 is positioned over the field 120, would cause the user to exit out of the menu 110 and to return to a previous menu from which the user arrived at the menu 110 shown in screen A of FIG. 4A.

On the other hand, when the cursor 130 is positioned over the field 120 called “BACK” as in screen A of FIG. 4A, if the rotary dial 102 is rotated (e.g., clockwise), the rotation of the rotary dial 102 causes the cursor 130 to toggle from the field 120 called “BACK” to the field 120 (called “S01-GREENS”) positioned immediately below as shown in screen B of FIG. 4A. With reference to screen B of FIG. 4A, the cursor 130 is now positioned over the field 120 called “S01-GREENS,” which may denote a reference to an irrigation zone associated with the greens of a golf course and including one or more irrigation stations (the illustrated example shows 4 irrigation stations). Notably, since the field 120 called “S01-GREENS” is larger in size than the field 120 called “BACK,” when the cursor is positioned over the field 120 called S01-GREENS, the size of the cursor 130 increases such that, in this example, the cursor 130 extends substantially across the entire display screen 106. In other words, in some embodiments, the cursor 130 is configured to be variable in size depending on the size of the field 120 over which the cursor 130 is positioned.

In the embodiment illustrated in screen B of FIG. 4A, the field 120 called S01-GREENS includes a visual indicator 122, which in this example is in the form of a right-pointing triangle, and which indicates to a user that selecting the field 120 called “S01-GREENS,” for example, via depression of the rotary dial 102 while the cursor 130 is positioned over it, would cause the user to exit out of the menu 110 and advance to a sub-menu that provides further options to the user with respect to the irrigation stations associated with the field 120 called “S01-GREENS.”

If, while the cursor 130 is positioned over the field 120 called “S01-GREENS” as in screen B of FIG. 4A, the rotary dial 102 is rotated (e.g., clockwise), the rotation of the rotary dial 102 would cause the cursor 130 to toggle from the field 120 called “S01-GREENS” to the field 120 (called “S02-TEES”) positioned immediately below as shown in screen C of FIG. 4A. With reference to screen C of FIG. 4A, the cursor 130 is now positioned over the field 120 called “S02-TEES,” which may denote a reference to an irrigation zone associated with the tees of a golf course and including one or more irrigation stations (the illustrated example shows 8 irrigation stations). As can be seen in screen C of FIG. 4A, the field 120 called “S02-TEES” includes a visual indicator 122, which in this example is in the form of a right-pointing triangle, and which indicates to a user that selecting the field 120 called “S02-TEES,” e.g., via depression of the rotary dial 102 while the cursor 130 is positioned over it, would cause the user to exit out of the menu 110 and advance to a sub-menu that provides further options to the user with respect to the irrigation stations of an irrigation zone associated with the field 120 called “S02-TEES.”

If, while the cursor 130 is positioned over the field 120 called “S02-TEES” as in screen C of FIG. 4A, the rotary dial 102 is rotated (e.g., clockwise), the rotation of the rotary dial 102 would cause the cursor 130 to toggle from the field 120 called “S02-TEES” to the field 120 positioned immediately below as shown in screen D of FIG. 4A. With reference to screen C of FIG. 4A, the cursor 130 is now positioned over the field 120 called “S03.” In the embodiment illustrated in screen D of FIG. 4A, the field 120 called “S03” does not yet have a specific name associated with it. However, since the field 120 called “S03” does not yet have a schedule associated with it, the field 120 called “S03” displays a message called “NEW SCHEDULE” that visually indicates to the user that the user may input various options/parameters in association with the irrigation stations of an irrigation zone associated with the field 120 called S03.

As can be seen in screen D of FIG. 4A, the field 120 called “S03” includes a visual indicator 122, which in this example is in the form of a right-pointing triangle, and which indicates to a user that selecting the field 120 called “S03,” e.g., via depression of the rotary dial 102 while the cursor 130 is positioned over it, would cause the user to exit out of the menu 110 and advance to a sub-menu 112 shown in screen E of FIG. 4A that provides further options to the user with respect to the irrigation stations associated with the field 120 called “S03.”

Screen E of FIG. 4A shows an exemplary sub-menu 112 including various interactive user-selectable fields 140 called “NAME,” “METHOD,” “START TIME,” and “STATION” (which, for simplicity, are also referred to herein simply as “fields”). The cursor 130, which may be toggled between the fields 140 within the sub-menu 112 by the user, for example, by rotation of the rotary dial 102, is positioned in screen E of FIG. 4A over the field 120 called “BACK.”

With reference to screen E of FIG. 4A, when the cursor 130 is positioned over the field 120 called “BACK,” if the rotary dial 102 is rotated (e.g., clockwise), the rotation of the rotary dial 102 causes the cursor 130 to toggle from the field 120 called “BACK” to the field 120 positioned immediately below it, such that the cursor toggles from the field 120 called “BACK” to the field 140 called “NAME,” as shown in screen F of FIG. 4A, which permits the user to edit the name “S03” to another name that is preferred by the user. As can be seen in screen F of FIG. 4A, the field 140 called “NAME” visually shows the name (i.e., “S03”) currently assigned to an irrigation zone and includes an interactive visual indicator 142, which, in this example, is in the form of pencil-like symbol, and which indicates to a user that selecting the field 140 including the interactive indicator 142 (e.g., via depression of the rotary dial 102 while the cursor 130 is positioned over it) would cause the user to enter an edit mode, where the user is permitted to edit (e.g., toggle, increment, decrement, select) the name of the irrigation zone.

In particular, if, when the cursor 130 is positioned over the interactive indicator 142 as shown in screen F of FIG. 4A, a user presses the rotary dial 102, the pencil-like symbol disappears and the interactive indicator 142 becomes blank with the cursor 130 positioned over it as shown in screen G of FIG. 4B, indicating to the user that the user may now actively select a first letter of the name of the irrigation zone. In particular, the user would rotate the rotary dial 102 (e.g., clockwise or counterclockwise) to scroll through the letters of the alphabet until the first letter of the desired irrigation zone name appears on the screen 106 in the field overlaid by the cursor 130. In the example illustrated in screen H of FIG. 4B, the user-desired letter is “H.” Once the desired letter, i.e., “H,” is reached via rotation of the rotary dial 102, the user would press the rotary dial 102 to select the letter “H” as the first letter of the irrigation zone name.

In one aspect, after the first letter of the irrigation zone is selected by the user via depression of the rotary dial 102, the cursor 130 would move to the right, indicating to the user the activation of the interactive field 140 that permits the user to rotate the rotary dial 102 to scroll to the second desired letter of the name of the irrigation zone, after which the user would depress the rotary dial 102 to select the second letter. This process is repeated by the user letter by letter until the irrigation zone name is complete (in this example, the full irrigation zone name is “HOTSPOT”), after which the rotary dial 102 may be rotated (e.g., clockwise or counterclockwise) to move the cursor 130 from the field 140 called “NAME” to the field 140 right below it, which is called “METHOD” (see screen I of FIG. 4B), and which visually indicates the days of the week on which the irrigation stations of the irrigation zone actively irrigate.

In the example shown in screen I of FIG. 4B, after the user rotates the rotary dial 102 to move the cursor 130 from the field 140 called “NAME” to the field 140 called “METHOD,” the sub-menu 112 updates to include an interactive user-selectable field 144 called “CANCEL,” which permits the user to cancel the selection of the name “HOTSPOT” for irrigation zone S03, and to return to the previous menu 110. The exemplary sub-menu 112 shown in screen I of FIG. 4B further includes an interactive user-selectable field 146 called “SAVE,” which permits the user to save the selection of the name “HOTSPOT” for irrigation zone S03, and to return to the previous menu 110 (as indicated by the indicator 148, which, in this example, is a left-pointing triangle).

With reference to screen I of FIG. 4B, the field 140 called “METHOD” includes an interactive visual indicator 142, which, in this example, is in the form of pencil-like symbol, and which indicates to a user that selecting the interactive indicator 142 (e.g., via pressing the rotary dial 102 while the cursor 130 is positioned over it) would cause the user to enter an edit mode, where the user is permitted to edit (e.g., toggle, select, deselect) the days of the week on which the irrigation stations of the irrigation zone actively irrigate. In particular, when the cursor 130 is positioned over the interactive indicator 142 as shown in screen I of FIG. 4B, the user may depress the rotary dial 102 to cause the pencil-like symbol to disappear and to cause the cursor 130 to become positioned over the letter representing the first day of the week selectable by the user (i.e., “S” for Sunday, as shown in screen J of FIG. 4B).

If the user wishes for the irrigation stations of the irrigation zone to actively irrigate on Sunday, the user would depress the rotary dial 102 while the cursor 130 overlays the letter “S” (as shown in screen J of FIG. 4B) to set Sunday as being a day on which the irrigation stations of the irrigation zone actively irrigate. On the other hand, if the user does not wish for the irrigation stations of the irrigation zone to actively irrigate on Sunday, the user would rotate the rotary dial 102 (e.g., clockwise) to move the cursor 130 from the letter “S” to the letter “M” (representing Monday) located immediately to the right of the letter “S.” While the cursor is positioned over the letter “M,” the user would either depress the rotary dial 102 to select “M” and set Monday as being a day on which the irrigation stations of the irrigation zone actively irrigate, or would rotate the rotary dial 102 (e.g., clockwise) to move the cursor 130 from the letter “M” to the letter “T” (representing Tuesday) located immediately to the right of the letter “M.”

This process of selecting the days of the week on which the irrigation stations of the irrigation zone actively irrigates is repeated until the user chooses all days of the week on which the user desires the irrigation stations of the irrigation zone to actively irrigate, after which the rotary dial 102 may be rotated (e.g., clockwise or counterclockwise) to move the cursor 130 from overlaying the field 140 called “METHOD” to overlaying the default time of “00:00 AM” in the field 140 right below it, which is called “START TIME” (see screen K of FIG. 4B), and which visually indicates the time at which the irrigation stations of the irrigation zone start actively irrigating.

With reference to screen K of FIG. 4B, the field 140 called “START TIME” includes an interactive visual indicator 142, which, in this example, is in the form of pencil-like symbol, and which indicates to a user that selecting the field 140 including interactive indicator 142 (e.g., via depression of the rotary dial 102 while the cursor 130 is positioned over it) would cause the user to enter an edit mode, where the user is permitted to edit (e.g., scroll through and select) the hours and minutes representing a time at which the irrigation stations of the irrigation zone starts actively irrigating. In particular, when the cursor 130 is positioned over the interactive indicator 142 as shown in screen K of FIG. 4B, if a user depresses the rotary dial 102, the pencil-like symbol would disappear and the cursor 130 would become positioned over the numbers representing the hours portion of the “START TIME.”

Thereafter, the user would rotate the rotary dial 102 (e.g., clockwise or counterclockwise) to scroll through the numbers until the desired hour is reached (in the example shown in screen L of FIG. 4B, the user chose “08”), after which the user would press the rotary dial 102 to select “08” as the hour, and after which the cursor 130 would move to the minutes portion (e.g., “00”) of the “START TIME.” Then, the user would rotate the rotary dial 102 (e.g., clockwise or counterclockwise) to scroll through the numbers until the desired minutes are reached, after which the user would press the rotary dial 102 to select the minutes (in this example, “00”), after which the cursor 130 would move to the AM/PM portion of the “START TIME,” where the user would rotate the rotary dial 102 (e.g., clockwise or counterclockwise) to scroll to either AM or PM and would then press the rotary dial 102 to select AM or PM (in this example, “AM” is selected).

In the example shown in screen L of FIG. 4B, when the cursor 130 is positioned over the interactive field 140 called “START TIME,” if the user is satisfied with the selection of the 08:00 AM start time of irrigation, the rotary dial 102 may be rotated (e.g., clockwise or counterclockwise) to move the cursor 130 from overlaying the field 140 called “START TIME” to overlaying the field 140 called “SELECT” located immediately below the field 140 called “START TIME.” In some aspects, the user may press the rotary dial 102 while it is positioned over the “SELECT” portion of the field 140 called “STATION,” which would allow the user to use rotation and/or depression of the rotary dial 102 to scroll through and select one or more irrigation stations of the irrigation zone S03, and to scroll through and select irrigation duration times (e.g., hours, minutes, seconds) for one or more of the irrigation stations of irrigation zone S03.

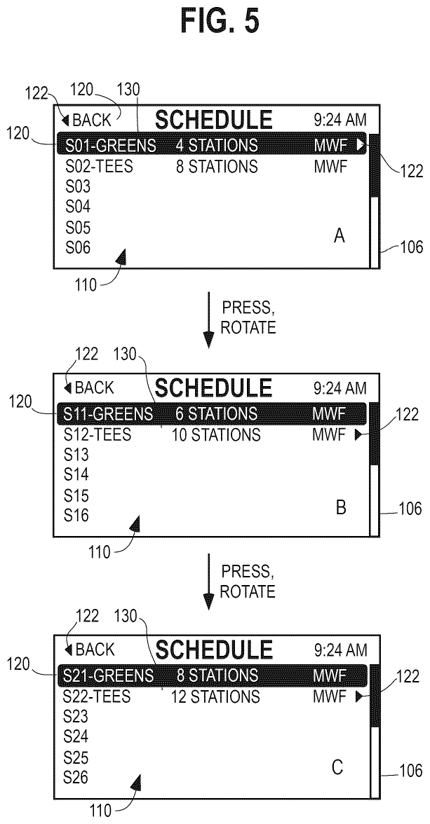

After the user returns to the menu 110 shown in screen D of FIG. 4A, the user can rotate the rotary dial 102 to navigate the user-selectable fields 120 (e.g., S01-GREENS, S02-TEES, S03, S04, S05, S06, etc.) within the menu 110, and to press the rotary dial 102 to make selections and/or input data within the menu 110 and/or to exit out of the menu 110 and/or to advance to the sub-menu 112 and/or to advance to other sub-menus available to the user. It will be appreciated that the menu 110 and sub-menu 112 shown in screens A-L of FIGS. 4A and 4B are shown to represent two exemplary menus that the user can interact with using the rotary dial 102, and that the rotary dial 102 (alone, or in combination with pressable buttons 104A-104D of the control panel 100) may be used to navigate and/or input data into other menus. FIGS. 5-14 depict various examples of menu navigation and/or data entry using a multi-function rotary dial and/or other user inputs within other example menus in accordance with some embodiments.

Referring next to FIG. 5, a multiple field increment/decrement feature is described which when activated, can allow a user to increment or decrement the cursor position to user-selectable fields by more than one selection per each rotation position of the rotary dial. FIG. 5 represents an example, where the rotary dial 102 is used in combination with a pressable button 104D of the control panel 100 to navigate through a menu 310. With reference to screen A of FIG. 5, the cursor 330 is positioned over the field 320 called “S01-GREENS.” As discussed above with reference to screens B and C of FIG. 4A, if, while the cursor 330 is positioned over the field 320 called “S01-GREENS,” the rotary dial 102 is rotated (e.g., clockwise), the rotation of the rotary dial 102 would cause the cursor 330 to toggle from the field 320 called “S01-GREENS” to the field 320 positioned immediately below (i.e., to the field 320 called “S02-TEES”). In other words, rotation of the rotary dial 102 while the button 104D of the control panel 100 is not pressed causes the cursor 330 to scroll down (or up) by one field 320.

On the other hand, if, while the cursor 330 is positioned over the field 320 called “S01-GREENS” as in screen A of FIG. 5, the user presses the button 104D and, while the button 104D is pressed, rotates the rotary dial 102 (e.g., clockwise), the rotation of the rotary dial 102 would cause the cursor 330 to scroll down not in a one-field increment (or decrement, if rotated counterclockwise) to the field 320 called “S02-TEES” located immediately below the field 320 called “S01-GREENS,” but would instead cause the cursor 330 to scroll down in a ten-field increment to the field 320 called “S11” to a position shown in screen B of FIG. 5 that is located ten fields down relative to the “S01-GREENS” field 320. In other words, in some aspects, rotation of the rotary dial 102 while pressing down the button 104D permits the user to scroll from one page of the menu 110 directly to the next consecutive page of the menu 110, such that the user may scroll faster through a listing of items of a menu 110, which is convenient when the listing of the menu 110 includes dozens or hundreds of selectable items. It is understood that incrementing or decrementing by ten field is by way of example only, and that the multiple field increment/decrement function may be configured to increment/decrement in any desired number of fields.

When the cursor 330 is positioned over the field 320 called “S11” as in screen B of FIG. 5, if the user presses the button 104D and, while the button 104D is pressed, rotates the rotary dial 102 (e.g., counterclockwise), the rotation of the rotary dial 102 would cause the cursor 330 to scroll back up in a ten-field increment to the field 320 called “S01-GREENS” located ten fields above the field 320 called “S11.” On the other hand, when the cursor 330 is positioned over the field 320 called “S11” as in screen B of FIG. 5, if the user presses the button 104D and, while the button 104D is pressed, rotates the rotary dial 102 (e.g., clockwise), the rotation of the rotary dial 102 would cause the cursor 330 to scroll down another ten-field increment to the field 320 called “S21” (as shown in screen C of FIG. 5) located ten fields above the field 320 called “S11.”

Similar to that shown in FIG. 5, a multiple value increment/decrement feature may be provided which when activated, can allow a user to increment or decrement an editable value by more than one value per each rotation position of the rotary dial 102. For example, should the user have the cursor positioned in a value selection field and use the rotary dial to input a value, the pressing of button 104D together with rotary dial 102 rotation, may cause the value field to increment by multiple values per single rotation position instead of increment by one value per single rotation position. For example, if the user navigates to the interactive visual indicator 142 corresponding to a letter (value) of the “NAME” field 140 of screen H of FIG. 4B, the pressing of button 104D may cause the value of the letter to increase by more than one value per rotation position. For example, if the multiple value increment was by ten (or five) values, the value would increase or decrease by ten (or five) values. For example, if the starting value were “A”, rotation without activation of button 104D would increment to “B”, then “C” per single rotation position of the rotary dial 102. And if button 104D were activated, each rotation position of the rotary dial 102 would increment to “K” if 10 value increment (or “F” if 5 value increment), then increment to “U” if 10 value increment (or “K” if 5 value increment). This can more quickly get the user to the desired value with fewer rotation position changes of the rotary dial 102. Again, the value of the increment of ten or five values are shown by way of example.

Further, while some of the example fields have selectable values in a single character field, such as interactive visual indicator 142 corresponding to a letter of screen H of FIG. 4B, some value entry fields may be multiple characters. For example, if a particular field requiring a value entry were numeric and selectable from any value between 0 and 999 (i.e., a 3 digit/character field selection), for example, the multiple value increment/decrement feature could more quickly allow a user to reach a number in the range. For example, to reach value 632 starting from 0, the user could activate a multiple value increment of ten using the button 104D to navigate from 0, 10, 20, 30, 40, 50, . . . 620, 630 with each rotation position, then deactivate the multiple value increment/decrement feature and navigate from 630 to 631, then 632 in the last rotation position changes. This would prevent the user from rotating the rotary dial 632 rotation positions to reach the same value.

In some embodiments, the multiple field and/or multiple value increment/decrement feature is activated by pressing the button 104D and holding it pressed while rotating, and deactivated by releasing the button 104D (i.e., no longer pressing it). Thus, while button 104D is pressed, the multiple field and/or multiple value increment/decrement feature is activated. In some embodiments, the feature is activated by pressing the button 104D without requiring holding the button 104D in a pressed position, and then deactivated with a second pressing of the button 104D, such that the feature is active after the first press of button 104D and until the second press of button 104D.

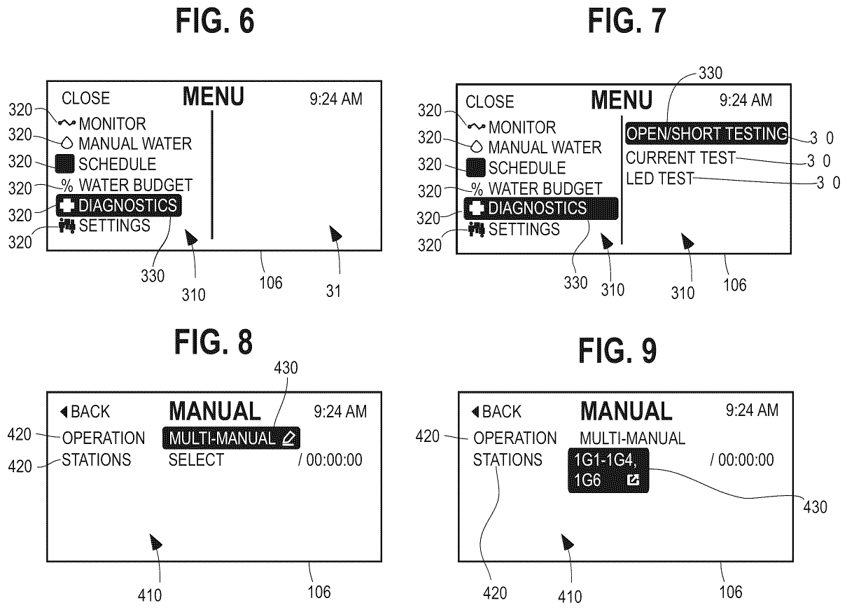

FIG. 6 shows an exemplary menu 310 including various interactive user-selectable fields 320 and a cursor 330, which may be toggled between the fields 320 within the menu 310 by the user via, for example, rotation of the rotary dial 102. In FIG. 6, the fields 320 that the user may navigate the cursor 330 to (e.g., via clockwise and/or counterclockwise rotation of the rotary dial 102) include “CLOSE,” “MONITOR,” “MANUAL WATER,” “SCHEDULE,” “% WATER BUDGET,” “DIAGNOSTICS,” AND “SETTINGS.” When the cursor 330 is positioned on (e.g., as an overlay over) one of these fields 320 (in FIG. 6, the cursor 330 is shown positioned over the field 320 called “DIAGNOSTICS”), the user may press the rotary dial 102 to select the field 320 called “DIAGNOSTICS,” and to advance to a sub-menu 312 associated with the field 320 called “DIAGNOSTICS.”

With reference to FIG. 7, an exemplary sub-menu 312 associated with the field 320 called “DIAGNOSTICS” includes user selectable fields 340 such as “OPEN/SHORT TESTING,” “CURRENT TEST,” and “LED TEST.” When the cursor 330 is positioned on (e.g., as an overlay over) one of these fields 340 (in FIG. 7, the cursor 330 is shown positioned over the field 340 called “OPEN/SHORT TEST”), the user may press the rotary dial 102 to select this field 340, which initiates a test for open circuits and/or short circuits in the wiring associated with one or more irrigation zones (or with one or more specific irrigation stations) of the irrigation system controlled via the control panel 100. On the other hand, when the cursor 330 is positioned over the field 340 called “OPEN/SHORT TEST”), if the user desires to run a current test or an LED test, the user may rotate the rotary dial 102 once to cause the cursor 330 to move from the “OPEN/SHORT TEST” field 340 to the “CURRENT TEST” field 340, followed by pressing the rotary dial 102 to initiate the current test, or the user may rotate the rotary dial 102 twice to cause the cursor 330 to move from the “OPEN/SHORT TEST” field 340 to the “LED TEST” field 340, followed by pressing the rotary dial 102 to initiate the LED test.

FIG. 8 shows an exemplary menu 410 including various interactive user-selectable fields 420 and a cursor 330, which may be toggled between the fields 420 within the menu 410 by the user via, for example, rotation of the rotary dial 102. In FIG. 8, the fields 420 that the user may navigate the cursor 430 to (e.g., via clockwise and/or counterclockwise rotation of the rotary dial 102) include “OPERATION” and “STATIONS.” When the cursor 430 is positioned on (e.g., as an overlay over) one of these fields 420 (in FIG. 8, the cursor 430 is shown positioned over the “MULTI-MANUAL” portion of “OPERATION” field 420), the user may press the rotary dial 102 to make a selection of the field 420, and to cause the cursor 430 to move to the “STATIONS” field 420 (see FIG. 9), where the user may manually select the irrigation stations that the user desires to monitor and/or adjust the operational parameters of. FIG. 9 shows an example, where the user used rotation of the rotary dial 102 and depression of the rotary dial 102 to select irrigation stations 1G1-1G4 and 1G6 (while skipping irrigation station 1G5).

FIG. 10 shows the exemplary menu 410 with the cursor 430 being positioned on (e.g., as an overlay over) a “SELECT” portion of the “STATIONS” field 420. Here, the user may press the rotary dial 102 to select the “STATIONS” field 420 and to enter the edit mode for the “STATIONS” field 420, which in turn causes a sub-menu 412 to be generated on the display screen 106, as shown in FIG. 11. The exemplary sub-menu 412 shown in FIG. 11 includes two user-selectable fields 440 called “ALL STATIONS” and “GROUPS.” In FIG. 11, the cursor 430 is positioned over the “ALL STATIONS” field 440. In some aspects, if the user presses the rotary dial 102 to select the “ALL STATIONS” field 440, this selection by the user would cause the cursor 430 to automatically select (and overlay as shown in FIG. 11) all of the irrigation stations of the irrigation control system 10, which, in this example, is 96 irrigation stations.

In some aspects, the sub-menu 412 may include two informational fields 460 and 462, each of which may be optional, and each of which visually indicates the number of irrigation stations currently selected. In the example of FIG. 11, the field 460 states “96 STATIONS SELECTED,” while the field 462 simply depicts the number “96.” In some aspects, the sub-menu 412 may include a visual indicator 464 (in the example of FIG. 11, a checkmark) that visually indicates that a given irrigation station is selected. In the example shown in FIG. 11, since all irrigation stations are selected, a checkmark-like visual indicator 464 would appear in association with each one of the 96 irrigation stations selected by the user.

In some aspects, if, instead of pressing the rotary dial 102 to select the “ALL STATIONS” field 440, the user may rotate the rotary dial 102 to cause the cursor 430 to move to the “GROUPS” field 440, followed by pressing the rotary dial 102 while the cursor is positioned over the “GROUPS” field 440. This selection by the user would cause the sub-menu 412 to show a listing of the irrigation stations, where the user, instead of selecting all irrigation stations with one click as described above, could rotate and depress the rotary dial 102 to select one or more groups of irrigation stations to monitor and/or adjust the operational parameters of.

FIG. 12 shows an exemplary menu 510 including various interactive user-selectable fields 520 and a cursor 530, which may be toggled between the fields 520 within the menu 510 by the user via rotation of the rotary dial 102. In FIG. 12, the fields 320 that the user may navigate the cursor 330 to (e.g., via clockwise and/or counterclockwise rotation of the rotary dial 102) within the “STATUS” menu 510 include “ALARMS,” “ACTIVE,” “UPCOMING,” “RECENT,” and “FLOW.”

In the example depicted in FIG. 12, the “ALARMS” field visually depicts any alerts and/or fault conditions associated with one or more irrigation stations of the irrigation system. The “ACTIVE” field visually depicts a listing of the irrigation stations that are actively irrigating and for how much longer these irrigation stations are going to irrigate (in the illustrated example, the irrigation stations 1G1, 1G2, 1G3, and 1G4 of irrigation zone called “S01-GREENS” will irrigate for 5 minutes and 24 seconds more). The “UPCOMING” field visually depicts a listing of the irrigation stations that scheduled to irrigate and when these irrigation stations will start actively irrigating (in the illustrated example, the irrigation stations of the irrigation zone called “S02-FAIRWAYS” will start irrigating in 20 minutes and 24 seconds). The “RECENT” field of FIG. 12 visually depicts a listing of the irrigation zones that recently irrigated and how long ago they irrigated (in the illustrated example, the irrigation stations of irrigation zone “S03-HOTSPOT” irrigated 4 hours ago). The “FLOW” field of FIG. 12 visually depicts a water flow preset for the irrigation stations when they are irrigating (in the illustrated example, the flow is 325 gallons per minute (GPM)).

In the example depicted in FIG. 12, the cursor 530 is positioned on (e.g., as an overlay over) the field called “MENU,” and the user may rotate the rotary dial 102 to position the cursor 530 on any one of the “ALARMS,” “ACTIVE,” “UPCOMING,” “RECENT,” one “FLOW” fields 520, after which the user can press the rotary dial 102 to make a selection and to view informational fields and/or make edits/input selections, via rotation and/or depression of the rotary dial 102, within the one of the fields 520 selected by the user for viewing and/or editing. For example, the user could rotate the rotary dial 102 to position the cursor 530 over the “ALARMS” field 520, after which the user could press the rotary dial 102 to access the “ALARMS” field 520 to obtain more information regarding the alarm message “STATION FAULT AT 3G5,” which is visible in FIG. 12.

In particular, FIG. 13 shows a sub-menu 610 that the user may access by pressing the rotary dial 102 while the cursor 530 is positioned on the “ALARMS” field 520 of the menu 510. In the example shown in FIG. 13, the “ALARMS” sub-menu 610 includes a field 620 called “CODE” that indicates the code/type of the alarm condition (in this example, “STATION FAULT”), a field 620 called “TIMESTAMP” that indicates the month/date/year and time (in this example, Sep. 12, 2023 at 3:11 PM) when the alarm condition was detected, and a field 620 called “DESCRIPTION,” which includes information relating code/type of the alarm condition (in this example, “HIGH CURRENT DETECTED ON STATION 16-5GR2). In FIG. 13, the cursor 630 is positioned on the “BACK” field and, if the user presses the rotary dial 102, the user exits out of the “ALARMS” sub-menu 610 shown in FIG. 13 and returns back to the “STATUS” menu 510 shown in FIG. 12.

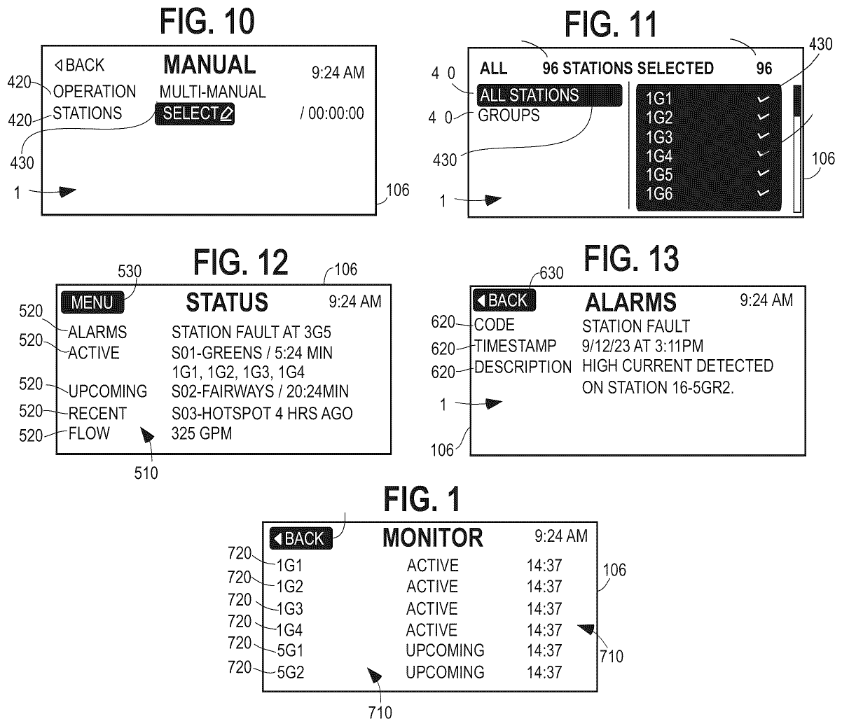

FIG. 14 shows a sub-menu 710 that the user may access by pressing the rotary dial 102 while the cursor 330 is positioned on the “MONITOR” field 320 of the menu 310 shown in FIG. 6. In the example shown in FIG. 14, the “MONITOR” sub-menu 710 includes fields 720, each of which indicates the name of an irrigation station (i.e., irrigation stations 1G1, 1G2, 1G3, 1G4, 5G1, and 5G2 are shown in FIG. 14), as well as the current status of the irrigation station with respect to whether the irrigation station is actively irrigating (the status is depicted as “ACTIVE” in FIG. 14), or whether the irrigation station is scheduled to irrigate at a predetermined time (the status is depicted as “UPCOMING” in FIG. 14).

In FIG. 14, the cursor 730 is positioned on the “BACK” field and, if the user were to press the rotary dial 102, the user would exit out of the “MONITOR” sub-menu 710 shown in FIG. 14 and would return back to the menu 310 shown in FIG. 6. Conversely, the user may rotate the rotary dial 102 to position the cursor 730 on any one of the irrigation stations listed in the fields 720, after which the user can press the rotary dial 102 to select to start, pause, or stop irrigation by the user-selected irrigation station that the user selected via depression of the cursor 730.

In some aspects, the user may use the rotary dial 102, in combination with the button 104D (see FIG. 3A) of the control panel 100, to select a group of two or more irrigation stations by positioning the cursor 730 over the irrigation stations, which would then enable the user to control multiple irrigation stations at once, and select to start, pause, or stop irrigation by the group of user-selected irrigation stations via depression of the cursor 730. For example, if the cursor 730 were located on irrigation station 1G1, and the user wanted to cause the two irrigation stations with an “UPCOMING” irrigation status to actively start irrigating, the user could rotate the rotary dial 102 to position the cursor 730 on the irrigation station 5G1. After that, the user would press the button 104D of the control panel 100 and, while the button 104D is pressed, the user would rotate the rotary dial 102 once to position the cursor over the irrigation station 5G1. This would cause the cursor 730 to overlay (i.e., simultaneously select) both irrigation stations 5G1 and 5G2. Then, the user could press the rotary dial 102 to, e.g., access a sub-menu that would permit the user to use rotation and depression of the rotary dial 102 to elect to immediately start active irrigation by the irrigation stations 5G1 and 5G2 (or to cancel irrigation by the stations 5G1 and 5G2 if the user had a change of mind and decided to cancel irrigation by these stations).

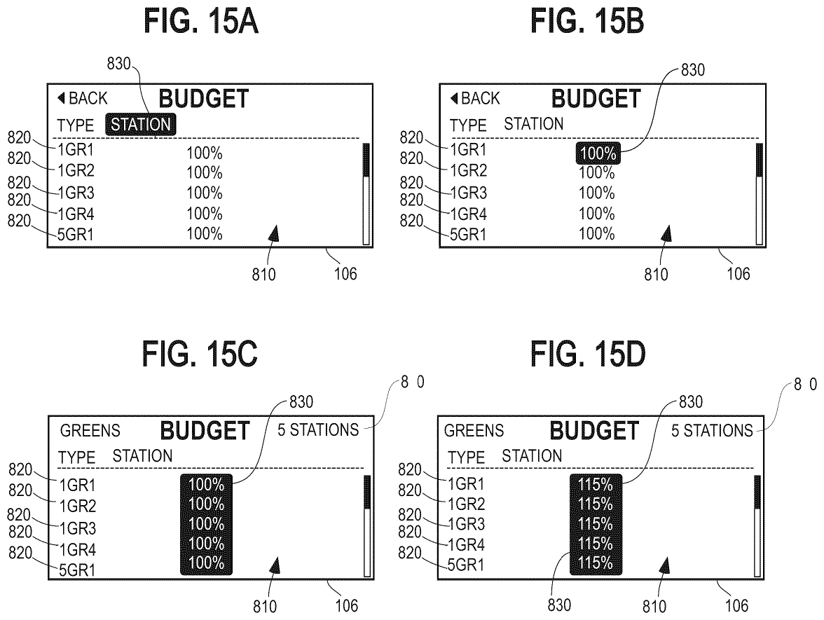

FIG. 15A shows an exemplary sub-menu 810 that the user may access by pressing the rotary dial 102 while the cursor 330 is positioned on the “% WATER BUDGET” field 320 of the menu 310 shown in FIG. 6. In the example shown in FIG. 15A, the “BUDGET” sub-menu 810 includes fields 820, each of which indicates the name of an irrigation station (irrigation stations 1GR1, 1GR2, 1GR3, 1GR4, and 5GR are shown in FIG. 15A), as well as the current setting (reflected by a percentage) with respect to the water use by each of the irrigation stations. In the example shown in FIG. 15A, each of the irrigation stations 1GR1, 1GR2, 1GR3, 1GR4, and 5GR is set to have a water budget of 100% (which may represent the baseline or standard amount of water preset for the irrigation stations according to the default settings of the irrigation control system 10).

When the cursor 830 is positioned on the “STATION” field as shown in FIG. 15A, if the user rotates the rotary dial 102 while the button 104D of the control panel 100 is not pressed, the user would cause the cursor 730 to move from the “STATION” field to the “100%” setting of the field 820 associated with the irrigation station 1GR1, as shown in FIG. 15B. When the cursor 830 is positioned on the “100%” setting of the field 820 associated with the irrigation station 1GR1 as shown in FIG. 15B, if the user rotates the rotary dial 102 while the button 104D of the control panel 100 is not pressed, the user would cause the cursor 830 to move from the “100%” setting of the field 820 associated with the irrigation station 1GR1 to the “100%” setting of the field 820 associated with the irrigation station 1GR2, which is located immediately below the field 820 associated with the irrigation station 1GR1.

On the other hand, in some embodiments, the user may activate a multiple field selection feature to allow for more than one field to be selected for edit. For example, when the cursor 830 is positioned on the “100%” setting portion of the field 820 associated with the irrigation station 1GR1 as shown in FIG. 15B, if the uses presses the button 104D and rotates the rotary dial 102 while the button 104D of the control panel 100 is pressed, the user would cause the cursor 830 to remain on the “100%” setting portion of the field 820 associated with the irrigation station 1GR1 and to also extend over the “100%” setting portion of the field 820 associated with the irrigation station 1GR2 (if the user turns the rotary dial 102 once), and to also extend over the “100%” setting portion of the field 820 associated with the irrigation station 1GR3 (if the user turns the rotary dial 102 twice), and to also extend over the “100%” setting portion of the field 820 associated with the irrigation station 1GR4 (if the user turns the rotary dial 102 three times), and to also extend over the “100%” setting portion of the field 820 associated with the irrigation station 5GR1 (if the user turns the rotary dial 102 four times), which ultimately may cause the cursor 830 to simultaneously overlay the “100%” setting portion of five fields 820 each respectively associated with one of five irrigation stations, namely, 1GR1, 1GR2, 1GR3, 1GR4, and 5GR, as shown in FIG. 15C. In the embodiment shown in FIG. 15C, the menu 810 may include an informational field 850, which may be optional, and which may visually indicate the number of irrigation stations currently selected (in this example, the information field 850 indicates “5 STATIONS” because five irrigation stations are selected).

In other words, the user may use the rotary dial 102, in combination with the button 104D of the control panel 100, to simultaneously select a group of two or more (and, in this case, five) irrigation stations (e.g., user selectable fields in the menu) by positioning the cursor 730 over the fields 820 associated with these irrigation stations, which enables the user to use the rotary dial 102 to simultaneously adjust the water budget allocated to each one of these five irrigation stations. In some embodiments, the group selection can be completed by releasing the button 104D and/or by pressing the rotary dial 102. In the illustrated example, while the cursor 830 overlays the “100%” setting portion of the five fields 820 each respectively associated with the five irrigation stations 1GR1, 1GR2, 1GR3, 1GR4, and 5GR, as shown in FIG. 15C. Next, in some embodiments, once the group of fields is selected, the user may: (1) press the rotary dial 102, followed by rotation of the rotary dial 102 (e.g., clockwise) to increase the water budget allocated to each of these five irrigation stations from 100% to 115%, as shown in FIG. 15D (or to a larger percentage, if the user desires); or (2) press the rotary dial 102, followed by rotation of the rotary dial 102 (e.g., counterclockwise) to decrease the water budget allocated to each of these five irrigation stations from 100% to a percentage that is lower than 100%. In some aspects, after the user sets the water budget allocated to each of the five irrigation stations 1GR1, 1GR2, 1GR3, 1GR4, and 5GR from 100% to a percentage desired by the user (in the example illustrated in FIG. 15D to 115%), the user would press the rotary dial 102 to input this setting, after which the user can rotate the rotary dial 102 to navigate to other portions of the sub-menu 810, or to another menu. In this way, by activating the multiple field selection feature, the user can select multiple fields (e.g., water budget for multiple stations) for input or edit, and make one input or edit (e.g., change 100% to 115%) that is applied the same to each field in the selection.

In some embodiments, the multiple field selection feature is activated by pressing the button 104D and holding it pressed while rotating, and deactivated by releasing the button 104D (i.e., no longer pressing it). Thus, while button 104D is pressed, the multiple field selection feature is activated. In some embodiments, the feature is activated by pressing the button 104D without requiring holding the button 104D in a pressed position, and then deactivated with a second pressing of the button 104D, such that the feature is active after the first press of button 104D and until the second press of button 104D. And in some embodiments, the pressing of button 104D may add a field to the multiple field selection group such that non-sequential fields may be selected for the group. That is, in some embodiments, the button 104D may be used to select certain ones of the fields. For example, in one example, the user presses button 104D to select 1GR1, then rotates the rotary dial 102 to move the cursor past fields 1GR2 and 1GR3 to navigate the cursor to field 1GR4, then presses button 104D to add field 1GR4 to the selection group, but not include fields 1GR2 and 1GR3 in the group. Similar fields may be added to the selected group by navigating to the desired fields and pressing the button 104D. To complete the group, in some embodiments once the desired fields are included, the user may press the rotary dial 102 to edit the value of the selected fields, or alternatively, press and hold the button 104D for a period of time (e.g., a long press), for example.

It is noted that while button 104D is described herein as having multiple different functions in different embodiments, in some embodiments, there may be multiple different buttons 104D, each having a dedicated function, wherein in other embodiments, the may be one button 104D and its function may be toggled between multiple functions using a separate function/mode button and/or one of the other buttons such as button 104A, 104C, for example.

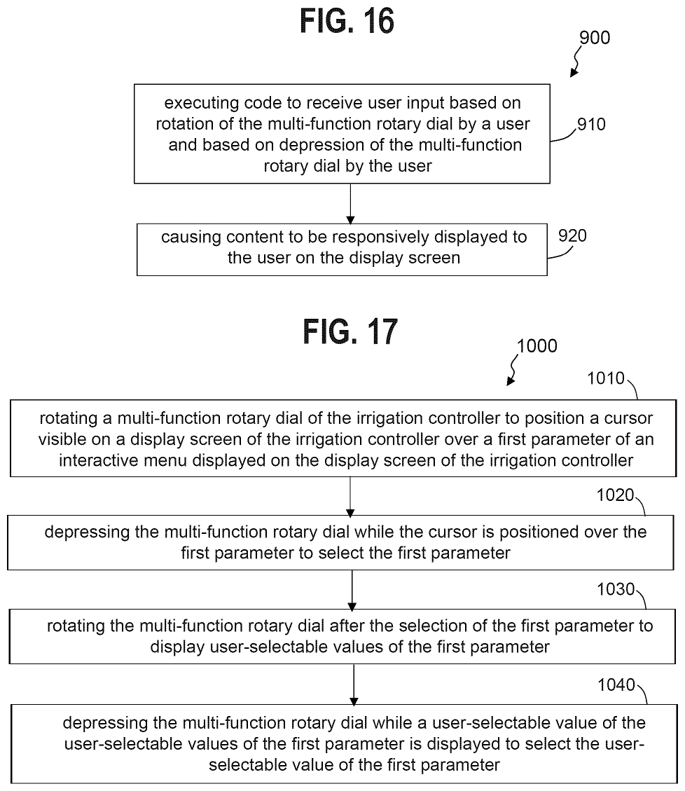

FIG. 16 illustrates a simplified flow diagram of an exemplary method 900 of controlling settings of an irrigation controller. The method 900 includes steps performed by the control circuit of a user interface of the irrigation controller, the user interface comprising a housing, a display screen, and a multi-function rotary dial coupled to the housing and configured to be rotated and pressed. In particular, step 910 of the method 900 includes executing code to receive user input based on rotation of the multi-function rotary dial by a user and based on depression of the multi-function rotary dial by the user. Step 920 of the method 900 includes causing content to be responsively displayed to the user on the display screen.

FIG. 17 illustrates a simplified flow diagram of an exemplary method 1000 entering settings of an irrigation controller. Step 1010 of the method 1000 includes rotating a multi-function rotary dial of the irrigation controller to position a cursor visible on a display screen of the irrigation controller over a first parameter of an interactive menu displayed on the display screen of the irrigation controller. Step 1020 of the method 1000 includes depressing the multi-function rotary dial while the cursor is positioned over the first parameter to select the first parameter. Step 1030 of the method 1000 includes rotating the multi-function rotary dial after the selection of the first parameter to display user-selectable values of the first parameter. Step 1040 of the method 1000 includes depressing the multi-function rotary dial while a user-selectable value of the user-selectable values of the first parameter is displayed to select the user-selectable value of the first parameter.

In some embodiments, a user interface of an irrigation controller can be implemented in a variety of ways. For example, a user interface may be implemented in a housing having user inputs (buttons and/or a multi-function rotary dial), user outputs (lights, display screen) and a control circuit (e.g., a microcontroller or microprocessor). A control circuit electrically coupled via a connection (e.g., a bus, etc.) to a memory and via a connection (e.g., a bus, etc.) to a power supply. In some embodiments, the control circuit is a programmable processor (e.g., a microprocessor or a microcontroller). And in some embodiments, the control circuit can comprise a fixed-purpose hard-wired platform or can comprise a partially or wholly programmable platform, such as a microcontroller, an application specification integrated circuit, a field programmable gate array, and so on.

The control circuit can be configured (for example, by using corresponding programming stored in the memory as will be well understood by those skilled in the art) to carry out one or more of the steps, actions, and/or functions described herein. In some embodiments, the memory may be integral to the control circuit or can be physically discrete (in whole or in part) from the control circuit and may be configured to non-transitorily store the computer instructions that, when executed by the control circuit, cause the control circuit to behave as described herein, e.g., to receive user inputs from buttons and/or a multi-function rotary dial and cause the display to display content and/or cause LEDs or indicator to illuminate. In some embodiments, a control circuit may be also electrically coupled via a connection to an input/output that can receive signals from other devices, for example, the central computer, central cloud server, one or more mobile devices, etc.

User interfaces may be caused to be displayed on various forms of interfaces, such as on a controller display screen with lights and buttons/switches/dials, a mobile device having a touch sensitive display screen and buttons/voice input and running a mobile application, a computer screen of a computer executing an irrigation application and using various user input devices, on a computing device as provided by a server or other central irrigation application transmitting content for display on the computing device, for example. Further details regarding various user interface displays may be found in one or more of the following patent documents, all incorporated herein by reference: U.S. Pat. No. 10,039,241 (Docket No. 8473-136242-US); and U.S. Application Publication No. 2023/0320295 (Docket No. 8473-156623-US).

Some embodiments provide a user interface for controlling settings of an irrigation controller. The user interface comprises: a housing; a display screen; a multi-function rotary dial coupled to the housing and configured to be rotated and pressed; and a control circuit configured to execute code to receive user input based on rotation of the multi-function rotary dial by a user and based on depression of the multi-function rotary dial by the user, and to cause content to be responsively displayed to the user on the display screen.

In some aspects, the rotation and depression of the multi-function rotary dial by the user allows the user to navigate a menu displayed to the user on the display screen. In some aspects, the rotation and depression of the multi-function rotary dial by the user allows the user to select data in a menu displayed to the user on the display screen, to input the data into the menu displayed to the user on the display screen, or to edit the data in the menu displayed to the user on the display screen. In some aspects, the control circuit is configured, in response to the rotation or depression of the multi-function rotary dial by the user, to allow the user to input or edit, through a combination of rotation and depression of the multi-function rotary dial, one or more of: menu options, area selection, manual watering, watering days, start times, watering duration, station name, station number, diagnostics, status options, alarm selections, watering status, station selection, station group selection, water budget, and water budget percentage.

In some embodiments, the control circuit is configured, in response to the rotation of the multi-function rotary dial by the user, to toggle a cursor between user-selectable fields within a menu displayed to the user on the display screen. In some aspects, the control circuit is configured, in response to the depression of the multi-function rotary dial by the user, to initiate a value selection mode of a user-selectable field pointed to by the cursor. In some aspects, the control circuit is configured, in response to the rotation of the multi-function rotary dial by the user, to toggle between user-selectable input values within the user-selectable fields. In some aspects, the control circuit is configured, in response to the depression of the multi-function rotary dial by the user, to select a user-selectable input value to be input into the user-selectable field. In some aspects, the control circuit is configured, in response to activation of a multiple value increment/decrement feature and the rotation of the multi-function rotary dial by the user, to toggle between user-selectable input values within the user-selectable fields by incrementing/decrementing multiple values per rotation position of the multi-function rotary dial.

In some implementations, the control circuit is configured, in response to activation of a multiple field increment/decrement feature and the rotation of the multi-function rotary dial by the user, to toggle a cursor between user-selectable fields within a menu displayed to the user on the display screen by incrementing/decrementing multiple user-selectable fields per rotation position of the multi-function rotary dial. In some implementations, the control circuit is configured, in response to activation of a multiple field select feature and the rotation of the multi-function rotary dial by the user, to toggle a cursor to select multiple user-selectable fields within a menu displayed to the user on the display screen for inclusion in a group of multiple user-selectable fields.

In certain implementations, the multi-function rotary dial has no defined rotational stop positions, such that the multi-function rotary dial is permitted to freely make a full 360-degree rotation clockwise or counterclockwise without stopping. In some aspects, the multi-function rotary dial does not include a visual position indicator configured to be aligned, by the rotation of the multi-function rotary dial, with at least one visual irrigation controller function indicator on the housing. In some aspects, a rotation of the multi-function rotary dial causes a cursor displayed to the user on the display screen to move from a first user-selectable field to a second user-selectable field located immediately below or next to the first user-selectable field.

In some embodiments, the user interface includes a pressable button, wherein the rotation of the multi-function rotary dial while the button is pressed causes the cursor displayed to the user on the display screen to move from the first user-selectable field to a third user-selectable field that is not located immediately below or next to the first user-selectable field, but that is located a predetermined number of increments away from the first user-selectable fields. In some aspects, the user interface includes a pressable button, wherein the rotation of the multi-function rotary dial while the button is pressed causes the cursor displayed to the user on the display screen to move from one page of a menu displayed to the user on the display screen to a next page of the menu. In some aspects, the user interface includes a pressable button, wherein the rotation of the multi-function rotary dial while the button is pressed and a cursor overlays one user-selectable field within a menu displayed to the user on the display screen causes the cursor to simultaneously overlay multiple user-selectable fields of the menu displayed to the user on the display screen.

In certain implementations, the user interface includes directional buttons that permit the user to navigate through the content displayed to the user on the display screen and a pressable button that permits the user to toggle between various modes of operation of the user interface.

Some embodiments provide a method of controlling settings of an irrigation controller, the method comprising: by the control circuit of a user interface of the irrigation controller, the user interface comprising a housing, a display screen, and a multi-function rotary dial coupled to the housing and configured to be rotated and pressed: executing code to receive user input based on rotation of the multi-function rotary dial by a user and based on depression of the multi-function rotary dial by the user; and causing content to be responsively displayed to the user on the display screen.

In some aspects, the method further includes permitting the user to rotate and depress the multi-function rotary dial to navigate a menu displayed to the user on the display screen. In some aspects, the method further includes permitting the user, to rotate and depress the multi-function rotary dial to select data in a menu displayed to the user on the display screen, to input the data into the menu displayed to the user on the display screen, or to edit the data in the menu displayed to the user on the display screen. In some aspects, the method further includes, by the control circuit, in response to the rotation or depression of the multi-function rotary dial by the user, permitting the user to input or edit, through a combination of rotation and depression of the multi-function rotary dial, one or more of: menu options, area selection, manual watering, watering days, start times, watering duration, station name, station number, diagnostics, status options, alarm selections, watering status, station selection, station group selection, water budget, and water budget percentage.

In some aspects, the method further includes, by the control circuit, in response to the rotation of the multi-function rotary dial by the user, toggling a cursor between user-selectable fields within a menu displayed to the user on the display screen. In some aspects, the method further includes, by the control circuit, in response to the depression of the multi-function rotary dial by the user, initiating a value selection mode of a user-selectable field pointed to by the cursor. In some aspects, the method further includes, by the control circuit, in response to the rotation of the multi-function rotary dial by the user, toggling between user-selectable input values within the user-selectable fields. In some aspects, the method further includes, by the control circuit, in response to the depression of the multi-function rotary dial by the user, selecting a user-selectable input value to be input into the user-selectable field. In some aspects, the method further includes, in response to activation of a multiple value increment/decrement feature and the rotation of the multi-function rotary dial by the user, toggling between user-selectable input values within the user-selectable fields by incrementing/decrementing multiple values per rotation position of the multi-function rotary dial.

In some embodiments, the method further includes, by the control circuit, in response to activation of a multiple field increment/decrement feature and the rotation of the multi-function rotary dial by the user, toggling a cursor between user-selectable fields within a menu displayed to the user on the display screen by incrementing/decrementing multiple user-selectable fields per rotation position of the multi-function rotary dial. And in some embodiments, the method further includes, by the control circuit, by the control circuit, in response to activation of a multiple field select feature and the rotation of the multi-function rotary dial by the user, toggling a cursor to select multiple user-selectable fields within a menu displayed to the user on the display screen for inclusion in a group of multiple user-selectable fields.

In some embodiments, the multi-function rotary dial has no defined rotational stop positions to permit the multi-function rotary dial to freely make a full 360-degree rotation clockwise or counterclockwise without stopping. In some embodiments, the multi-function rotary dial has no visual position indicator configured to be aligned, by the rotation of the multi-function rotary dial, with at least one visual irrigation controller function indicator on the housing.

In some embodiments, the method further includes, in response to a rotation of the multi-function rotary dial, causing a cursor displayed to the user on the display screen to move from a first user-selectable field to a second user-selectable field located immediately below or next to the first user-selectable field. In some embodiments, the method further includes, in response to a rotation of the multi-function rotary dial while pressing a pressable button of the user interface, causing the cursor displayed to the user on the display screen to move from the first user-selectable field to a third user-selectable field that is not located immediately below or next to the first user-selectable field, but that is located a predetermined number of increments away from the first user-selectable fields.

In some aspects, the method further comprises, in response to a rotation of the multi-function rotary dial while pressing a pressable button of the user interface, causing the cursor displayed to the user on the display screen to move from one page of a menu displayed to the user on the display screen to a next page of the menu.

In some aspects, the method further comprises, in response to a rotation of the multi-function rotary dial while pressing a pressable button of the user interface and while a cursor overlays one user-selectable field within a menu displayed to the user on the display screen, causing the cursor to simultaneously overlay multiple user-selectable fields of the menu displayed to the user on the display screen.

In some aspects, the method further comprises providing directional buttons that permit the user to navigate through the content displayed to the user on the display screen. In some aspects, the method further comprises providing a pressable button that permits the user to toggle between various modes of operation of the user interface.

Some embodiments provide a method of entering settings of an irrigation controller, the method comprising: rotating a multi-function rotary dial of the irrigation controller to position a cursor visible on a display screen of the irrigation controller over a first parameter of an interactive menu displayed on the display screen of the irrigation controller; depressing the multi-function rotary dial while the cursor is positioned over the first parameter to select the first parameter; rotating the multi-function rotary dial after the selection of the first parameter to display user-selectable values of the first parameter; and depressing the multi-function rotary dial while a user-selectable value of the user-selectable values of the first parameter is displayed to select the user-selectable value of the first parameter.

In certain aspects, the method further includes: rotating the multi-function rotary dial to position the cursor over a second parameter of the interactive menu; depressing the multi-function rotary dial while the cursor is positioned over the second parameter to select the second parameter; rotating the multi-function rotary dial after the selection of the second parameter to display user-selectable values of the second parameter; and depressing the multi-function rotary dial while a user-selectable value of the user-selectable values of the second parameter is displayed to select the user-selectable value of the second parameter.

In some implementations, the method further comprises rotating the multi-function rotary dial to cause the cursor to move from the first parameter to the second parameter, the second parameter being located immediately below or next to the first parameter. In some implementations, the method further comprises, while pressing a pressable button of the user interface, rotating the multi-function rotary dial to cause the cursor to move from the first parameter to another parameter located a predetermined number of parameters away from the first parameter. In some implementations, the method further comprises, while pressing a pressable button of the user interface and while the cursor overlays the first parameter, rotating the multi-function rotary dial to cause the cursor to simultaneously overlay at least the first parameter and the second parameter.

In some aspects, the method further includes navigating through the interactive menu by pressing one or more directional buttons of the irrigation controller. In some aspects, the method further includes toggling between various modes of operation of the irrigation controller by pressing a pressable button of the irrigation controller.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A user interface for controlling settings of an irrigation controller, the user interface comprising:
a housing;
a display screen;
a multi-function rotary dial coupled to the housing and configured to be rotated and pressed; and
a control circuit configured to execute code to receive user input based on rotation of the multi-function rotary dial by a user and based on depression of the multi-function rotary dial by the user, and to cause content to be responsively displayed to the user on the display screen.

2. The user interface of claim 1, wherein the rotation and depression of the multi-function rotary dial by the user allows the user to navigate a menu displayed to the user on the display screen.

3. The user interface of claim 1, wherein the rotation and depression of the multi-function rotary dial by the user allows the user to select data in a menu displayed to the user on the display screen, to input the data into the menu displayed to the user on the display screen, or to edit the data in the menu displayed to the user on the display screen.

4. The user interface of claim 3, wherein the control circuit is configured, in response to the rotation or depression of the multi-function rotary dial by the user, to allow the user to input or edit, through a combination of rotation and depression of the multi-function rotary dial, one or more of: menu options, area selection, manual watering, watering days, start times, watering duration, station name, station number, diagnostics, status options, alarm selections, watering status, station selection, station group selection, water budget, and water budget percentage.

5. The user interface of claim 1, wherein the control circuit is configured, in response to the rotation of the multi-function rotary dial by the user, to toggle a cursor between user-selectable fields within a menu displayed to the user on the display screen.

6. The user interface of claim 5, wherein the control circuit is configured, in response to the depression of the multi-function rotary dial by the user, to initiate a value selection mode of a user-selectable field pointed to by the cursor.

7. The user interface of claim 6, wherein the control circuit is configured, in response to the rotation of the multi-function rotary dial by the user, to toggle between user-selectable input values within the user-selectable fields.

8. The user interface of claim 6, wherein the control circuit is configured, in response to the depression of the multi-function rotary dial by the user, to select a user-selectable input value to be input into the user-selectable field.

9. The user interface of claim 6, wherein the control circuit is configured, in response to activation of a multiple value increment/decrement feature and the rotation of the multi-function rotary dial by the user, to toggle between user-selectable input values within the user-selectable fields by incrementing/decrementing multiple values per rotation position of the multi-function rotary dial.

10. The user interface of claim 1, wherein the control circuit is configured, in response to activation of a multiple field increment/decrement feature and the rotation of the multi-function rotary dial by the user, to toggle a cursor between user-selectable fields within a menu displayed to the user on the display screen by incrementing/decrementing multiple user-selectable fields per rotation position of the multi-function rotary dial.

11. The user interface of claim 1, wherein the control circuit is configured, in response to activation of a multiple field select feature and the rotation of the multi-function rotary dial by the user, to toggle a cursor to select multiple user-selectable fields within a menu displayed to the user on the display screen for inclusion in a group of multiple user-selectable fields.

12. The user interface of claim 1, wherein the multi-function rotary dial has no defined rotational stop positions, such that the multi-function rotary dial is permitted to freely make a full 360-degree rotation clockwise or counterclockwise without stopping.

13. The user interface of claim 1, wherein the multi-function rotary dial does not include a visual position indicator configured to be aligned, by the rotation of the multi-function rotary dial, with at least one visual irrigation controller function indicator on the housing.

14. The user interface of claim 1, wherein a rotation of the multi-function rotary dial causes a cursor displayed to the user on the display screen to move from a first user-selectable field to a second user-selectable field located immediately below or next to the first user-selectable field.

15. The user interface of claim 14, further comprising a pressable button, wherein the rotation of the multi-function rotary dial while the button is pressed causes the cursor displayed to the user on the display screen to move from the first user-selectable field to a third user-selectable field that is not located immediately below or next to the first user-selectable field, but that is located a predetermined number of increments away from the first user-selectable fields.

16. The user interface of claim 14, further comprising a pressable button, wherein the rotation of the multi-function rotary dial while the button is pressed causes the cursor displayed to the user on the display screen to move from one page of a menu displayed to the user on the display screen to a next page of the menu.

17. The user interface of claim 14, further comprising a pressable button, wherein the rotation of the multi-function rotary dial while the button is pressed and a cursor overlays one user-selectable field within a menu displayed to the user on the display screen causes the cursor to simultaneously overlay multiple user-selectable fields of the menu displayed to the user on the display screen.

18. A method of controlling settings of an irrigation controller, the method comprising:
by a control circuit of a user interface of the irrigation controller, the user interface comprising a housing, a display screen, and a multi-function rotary dial coupled to the housing and configured to be rotated and pressed:
executing code to receive user input based on rotation of the multi-function rotary dial by a user and based on depression of the multi-function rotary dial by the user; and
causing content to be responsively displayed to the user on the display screen.

19. The method of claim 18, further comprising permitting the user to rotate and depress the multi-function rotary dial to navigate a menu displayed to the user on the display screen.

20. The method of claim 18, further comprising permitting the user, to rotate and depress the multi-function rotary dial to select data in a menu displayed to the user on the display screen, to input the data into the menu displayed to the user on the display screen, or to edit the data in the menu displayed to the user on the display screen.

21. The method of claim 18, further comprising, by the control circuit, in response to the rotation or depression of the multi-function rotary dial by the user, permitting the user to input or edit, through a combination of rotation and depression of the multi-function rotary dial, one or more of: menu options, area selection, manual watering, watering days, start times, watering duration, station name, station number, diagnostics, status options, alarm selections, watering status, station selection, station group selection, water budget, and water budget percentage.

22. The method of claim 18, further comprising, by the control circuit, in response to the rotation of the multi-function rotary dial by the user, toggling a cursor between user-selectable fields within a menu displayed to the user on the display screen.

23. The method of claim 22, further comprising, by the control circuit, in response to the depression of the multi-function rotary dial by the user, initiating a value selection mode of a user-selectable field pointed to by the cursor.

24. The method of claim 23, further comprising, by the control circuit, in response to the rotation of the multi-function rotary dial by the user, toggling between user-selectable input values within the user-selectable fields.

25. The method of claim 23, further comprising, by the control circuit, in response to the depression of the multi-function rotary dial by the user, selecting a user-selectable input value to be input into the user-selectable field.

26. The method of claim 23, further comprising, by the control circuit, in response to activation of a multiple value increment/decrement feature and the rotation of the multi-function rotary dial by the user, toggling between user-selectable input values within the user-selectable fields by incrementing/decrementing multiple values per rotation position of the multi-function rotary dial.

27. The method of claim 18, further comprising, by the control circuit, in response to activation of a multiple field increment/decrement feature and the rotation of the multi-function rotary dial by the user, toggling a cursor between user-selectable fields within a menu displayed to the user on the display screen by incrementing/decrementing multiple user-selectable fields per rotation position of the multi-function rotary dial.

28. The method of claim 18, further comprising, by the control circuit, in response to activation of a multiple field select feature and the rotation of the multi-function rotary dial by the user, toggling a cursor to select multiple user-selectable fields within a menu displayed to the user on the display screen for inclusion in a group of multiple user-selectable fields.

29. The method of claim 18, wherein the multi-function rotary dial has no defined rotational stop positions to permit the multi-function rotary dial to freely make a full 360-degree rotation clockwise or counterclockwise without stopping.

30. The method of claim 18, wherein the multi-function rotary dial has no visual position indicator configured to be aligned, by the rotation of the multi-function rotary dial, with at least one visual irrigation controller function indicator on the housing.

31. The method of claim 18, further comprising, in response to a rotation of the multi-function rotary dial, causing a cursor displayed to the user on the display screen to move from a first user-selectable field to a second user-selectable field located immediately below or next to the first user-selectable field.

32. The method of claim 31, further comprising, in response to a rotation of the multi-function rotary dial while pressing a pressable button of the user interface, causing the cursor displayed to the user on the display screen to move from the first user-selectable field to a third user-selectable field that is not located immediately below or next to the first user-selectable field, but that is located a predetermined number of increments away from the first user-selectable fields.

33. The method of claim 31, further comprising, in response to a rotation of the multi-function rotary dial while pressing a pressable button of the user interface, causing the cursor displayed to the user on the display screen to move from one page of a menu displayed to the user on the display screen to a next page of the menu.

34. The method of claim 31, further comprising, in response to a rotation of the multi-function rotary dial while pressing a pressable button of the user interface and while a cursor overlays one user-selectable field within a menu displayed to the user on the display screen, causing the cursor to simultaneously overlay multiple user-selectable fields of the menu displayed to the user on the display screen.

35. A method of entering settings of an irrigation controller, the method comprising:
rotating a multi-function rotary dial of the irrigation controller to position a cursor visible on a display screen of the irrigation controller over a first parameter of an interactive menu displayed on the display screen of the irrigation controller;
depressing the multi-function rotary dial while the cursor is positioned over the first parameter to select the first parameter;
rotating the multi-function rotary dial after the selection of the first parameter to display user-selectable values of the first parameter; and
depressing the multi-function rotary dial while a user-selectable value of the user-selectable values of the first parameter is displayed to select the user-selectable value of the first parameter.

36. The method of claim 35, further comprising:
rotating the multi-function rotary dial to position the cursor over a second parameter of the interactive menu;
depressing the multi-function rotary dial while the cursor is positioned over the second parameter to select the second parameter;
rotating the multi-function rotary dial after the selection of the second parameter to display user-selectable values of the second parameter; and
depressing the multi-function rotary dial while a user-selectable value of the user-selectable values of the second parameter is displayed to select the user-selectable value of the second parameter.
